(19) United States
(12) Patent Application Publication
(10) Pub. No.: US 2025/0087186 A1
(43) Pub. Date: Mar. 13, 2025

(54) PORTABLE DRUM KIT

(71) Applicant: Randall Ryon, Victor, NY (US)

(72) Inventor: Randall Ryon, Victor, NY (US)

(21) Appl. No.: 18/800,112

(22) Filed: Aug. 11, 2024

Related U.S. Application Data
(60) Provisional application No. 63/538,064, filed on Sep. 12, 2023.

(51) Int. Cl. G10D 13/063; G10D 13/11; G10D 13/12; G10D 13/18; G10D 13/20

(52) U.S. Cl. CPC G10D 13/063; G10D 13/11; G10D 13/12; G10D 13/18; G10D 13/20

(57) ABSTRACT

The present invention is a drum comprising: a frame, wherein the frame has a base plate and wherein the base plate has an aperture; a top surface secured to the frame; a first side surface secured to the frame; a second side surface secured to the frame; a front plate secured to the frame; a snare assembly integrated into the frame and interfacing with the top surface; and a bass drum beater assembly secured to the frame.

### CROSS-REFERENCE TO RELATED APPLICATIONS

This application is a continuation-in-part (and claims the benefit of priority under 35 USC 120) of U.S. provisional application No. 63/538,064 filed Sep. 12, 2023. The disclosure of the prior applications is considered part of (and is incorporated by reference in) the disclosure of this application.

### BACKGROUND OF THE INVENTION

The present invention relates to drum kit, and more particularly to a portable drum kit contained in a single device.

A standard four-piece drum kit consists of a snare drum, a bass drum, a floor-mounted tom-tom drum (also referred to as a “floor tom”) and a tom-tom drum that is somewhat elevated and attached to a hanging device or rack (also referred to as a “rack tom”). Besides the drums, the kit generally includes cymbals, a floor pedal, and hardware for attaching the drums in their preferred configuration (as well, in some cases, a seat for the drummer). For every performance, this equipment needs to be packed, transported and then unloaded. When the performance is over, the equipment must once again be packed, transported home and unloaded. Not only is this tedious, but transportation space (such as in a car) is usually very limited. In most cases, the drums are packed in separate suitcases or trunks, making the entire collection of baggage a significant load.

It is desired for a single device that is capable of replicating the standard four-piece drum kit and cymbals for easy transportation and setup.

### SUMMARY

In a first embodiment, the present invention is a drum comprising: a frame; a base plate having an aperture attached to the frame; a top surface secured to the frame; a first side surface secured to the frame; and a second side surface secured to the frame.

In a second embodiment, the present invention is a drum comprising: a frame, wherein the frame has a base plate and wherein the base plate has an aperture; a top surface secured to the frame; a first side surface secured to the frame; a second side surface secured to the frame; a front plate secured to the frame; a snare assembly integrated into the frame and interfacing with the top surface; a bass drum beater assembly secured to the frame.

In a third embodiment, the present invention is a drum comprising: a frame, wherein the frame comprises: a base plate, at set of vertical members, wherein the vertical members interface with the base plate at predetermined positions, and a top plate secured to the set of vertical members; a top surface secured to the frame; a first side surface secured to the frame; a second side surface secured to the frame; a snare assembly integrated into the frame and interfacing with the top surface; a bass drum beater assembly secured to the frame; and a cymbal mount assembly attached to the base plate.

### BRIEF DESCRIPTION OF THE DRAWINGS

FIG. 1 depicts an isometric view of a portable drum, in accordance with one embodiment of the present invention.

FIG. 2 depicts an isometric view of the portable drum, in accordance with one embodiment of the present invention.

FIG. 3 depicts an isometric view of the portable drum, in accordance with one embodiment of the present invention.

FIG. 4 depicts an isometric view of the portable drum, in accordance with one embodiment of the present invention.

FIG. 5 depicts an isometric view of the portable drum, in accordance with one embodiment of the present invention.

FIG. 6 depicts an isometric view of the interior of the portable drum, in accordance with one embodiment of the present invention.

FIG. 7 depicts an isometric view of a cymbal taps assembly installed on a cymbal of the portable drum, in accordance with one embodiment of the present invention.

FIG. 8 depicts a side view of the cymbal taps assembly installed on a cymbal of the portable drum, in accordance with one embodiment of the present invention.

### DETAILED DESCRIPTION OF THE INVENTION

The present invention provides a drum kit or set that is contained within a single drum. For many years the drum industry has been relatively stagnant in producing innovative changes from traditional drum sets and kits. The advantages of the present invention are a novel design of a drum kit that allows for the drummer to have the full range of a 4-piece (or more) drum kit with cymbals all in a single drum that is easy to transport and set up. The drum kit is able to be played with various sticks, brushes, mallets as well as the user's hands.

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. With modifications to the shape and size, any sound can be replicated and/or produced. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates, which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

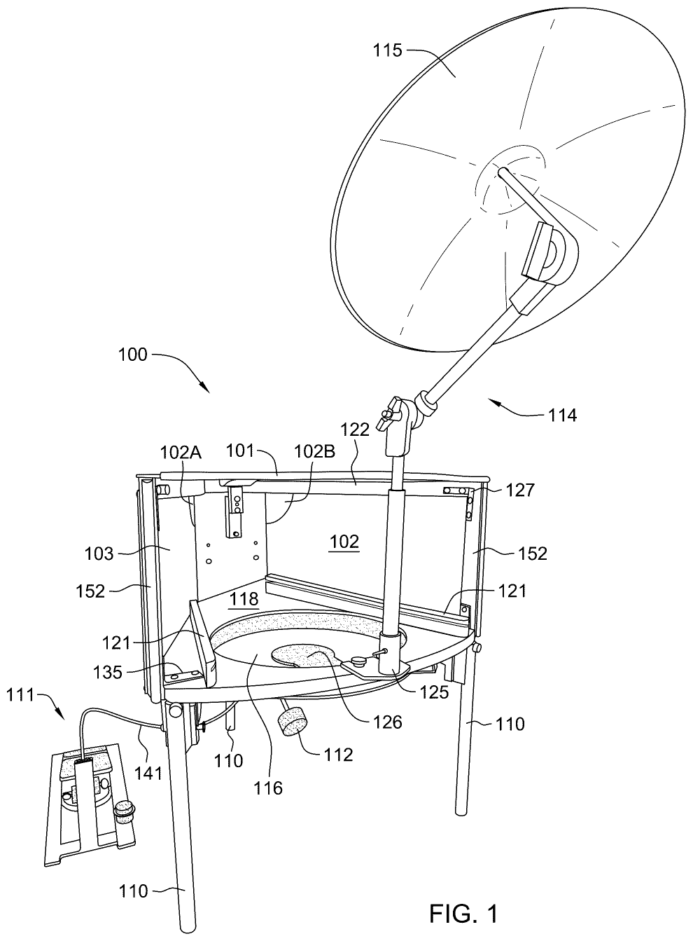

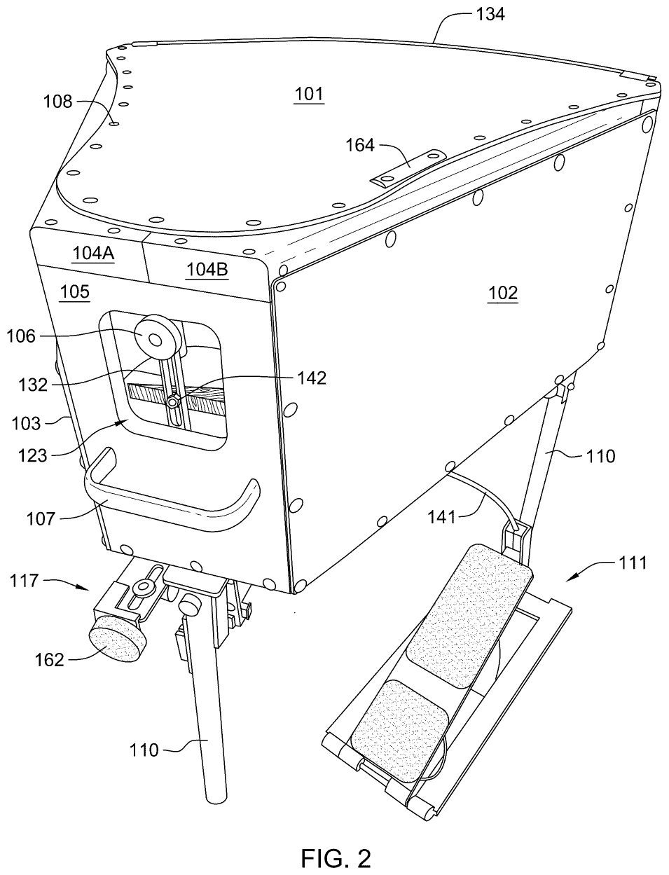

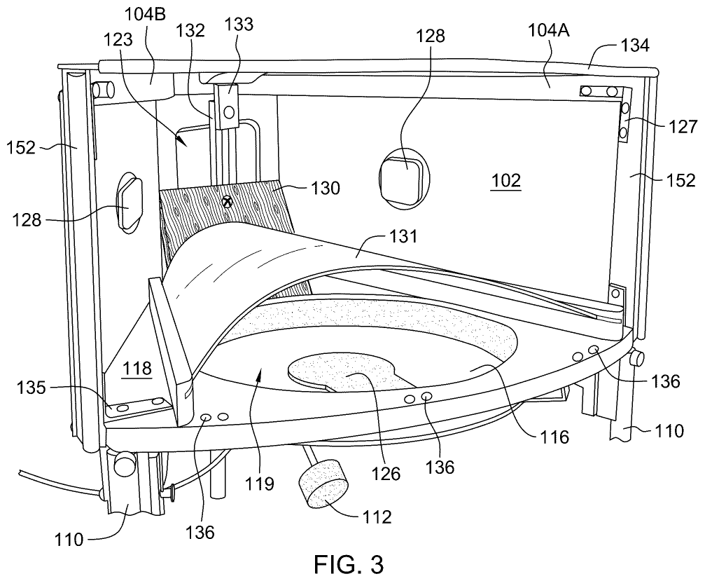

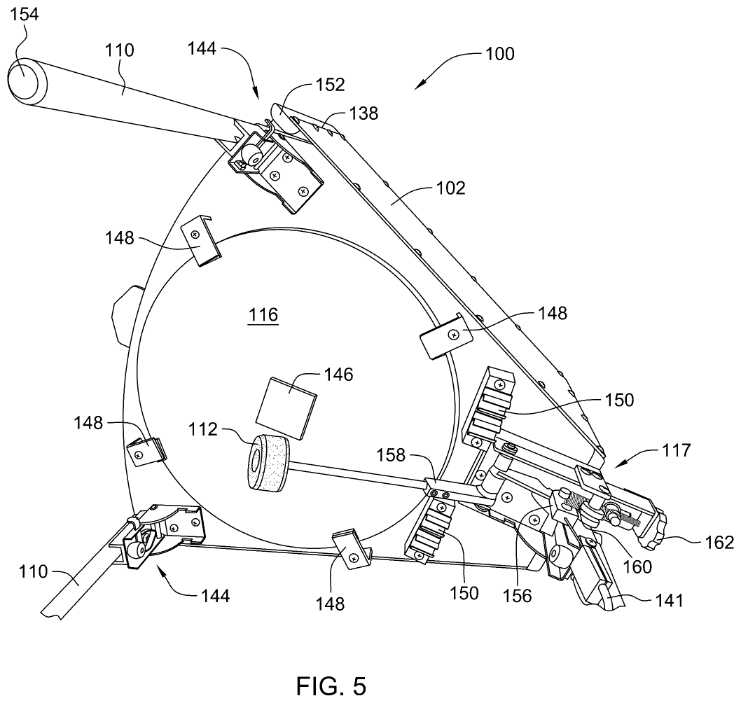

FIGS. 1-6 depict various views of a drum kit 100, in accordance with embodiments of the present invention.

The drum kit 100 (hereinafter “drum” “drum kit” “portable drum” or “portable drum kit”) provides a single structure that is able to produce a variety of sounds that mimic various components of a full drum kit. The drum 100 has a main body that is supported by a series of feet. In one embodiment, the main body has a trapezoidal-like shape with a curved outer edge. In additional embodiments, the main body has a bell-like shape with a curved outer edge. With modifications to the shape and size of the overall drum 100, many sounds can be replicated and/or produced with this single device. The main body has a top surface 101, side surface 102, side surface 103, and base plate 118. Each surface is able to produce a different tone/sound. Based on the size, shape, thickness, and material of each surface, a different sound can be produced. Each surface, based on the shape and contour, can produce a variety of different notes as the drummer hits the surface at different locations. The top surface 101 has a bell-like design in the depicted embodiment that is able to produce different notes as you move from one end to the other. In some embodiments, markings can be made on the surfaces to indicate different notes that can be produced by hitting different areas. In some embodiments, the surfaces 101, 102, 103 are made from thin birch plywood, garolite phenolic resin, polycarbonate plastic, or the like. Surface 101 can be segmented and use different materials to make unique tones.

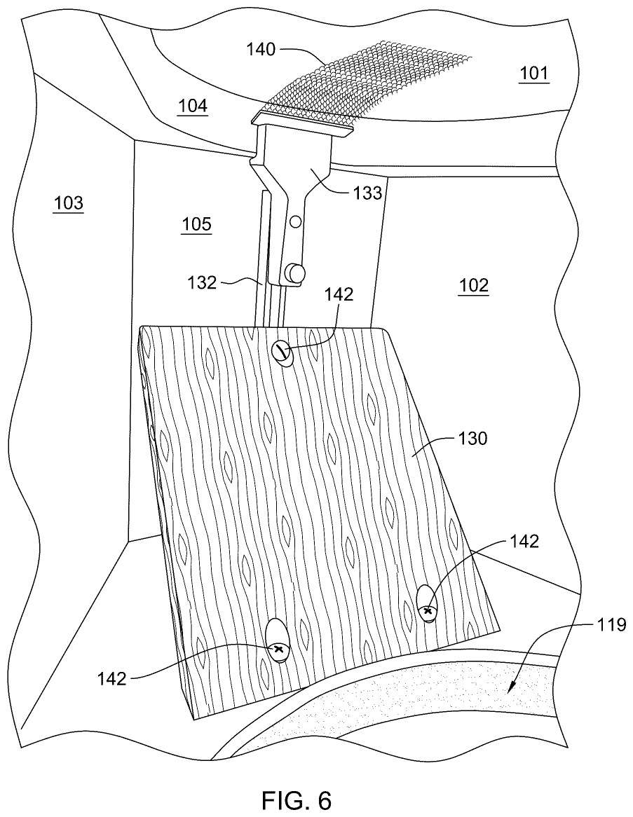

The drum 100 is comprised of a main body that provides structural support for the surfaces. The main body consists of frame members 104A and 104B, rear plate 105, front supports 152, and a base plate 118. The frame members 104A and 104B and the base plate 118 have substantially the same shape/contour. In some embodiments, frame members 104A and 104B are a single clement shown in FIG. 6 as frame member 122. These components are attached using brackets 127 and 135 with the necessary fasteners. In some embodiments, these components are held together using adhesives or other types of securement means and methods. The surfaces 101, 102, and 103 are attached to the frame that provides the structural support for the drum 100, as well as provide the shape for the overall surfaces 101, 102, and 103 which are applied to the frame. The frame can be made from various materials such as wood, metal, or plastic, such as but not limited to birch, plywood, or polycarbonate. The frame has a curved and flared overall design so that the sound pattern exiting the front of the drum is widened. The components that comprise the frame can be made from oak, maple, or other hardwoods. The surfaces 101, 102, and 103 are secured to the frame via fasteners 108 or the like. This allows for the removal and replacement of one or more components of the frame when either a different tone or note is desired, or a component is broken/damages. The size of the drum 100 and its frame components as well as the surfaces is based on the overall interior cavity size requirements which are based on the desired tones and sounds to be produced. In the depicted embodiment, a flexible weighted pads 128 is attached to surfaces 102 and 103 to enhance their bass response. In the depicted embodiment surfaces 102 and 103 have openings 102B and 102A respectively, these openings assist in producing the desired sound.

Secured to the fasteners 108 is a rim shot plate 164. The rim shot plate 164 is secured (as shown in the present embodiment) to two of the fasteners 108 and allows for the player to create a sound that is similar to a rim shot on a snare drum. The rim shot plate 164 is made from various metals depending on the preferred sound. The rim shot plate 164 may be placed in various locations on the drum based on the drummer's preference and the rim shot plate 164 may be of varying lengths, thicknesses, and materials.

The surface 101 is a flat plate with a horn shaped profile, where the narrow end produces high notes and progressively lower notes towards the wide end. The surface 101 has concave sides designed based on the intended sounds to be generated and the design of the frame member 104. In some embodiments, the surface 101 is made up of multiple segments to allow for different tonal qualities. On the front edge of the surface 101 is an edge guard 134, which both assists in protecting the surface 101 from damage, as well as affect the sound which is generated by the surface 101.

In some embodiments, on the rear plate 105 of the frame an aperture 123 is present. This aperture 123 allows for an improvement in bass and the overall sound of the drum.

The drum 100 has a feature that replicates a snare drum. The snare drum sizzler assembly is comprised of a mounting bracket 132 which is attached to rear plate 105. The mounting bracket 132 has a center slot that a snare wire mount 133 is inserted through with tuning knob 106 accessible from the exterior of the drum 100. The tuning knob 106 is attached to the snare wire mount 133. The snare wire mount 133 has a set of snare wires 140 attached that interface with surface 101. The snare wire assembly is able to allow the surface 101 to replicate the sound of a snare drum. The snare wires are able to be engaged and disengaged through the repositioning of the tuning knob 106. In the depicted embodiment, the snare wires engage with a predetermined area of surface 101 and affect mainly the narrow end of surface 101. Surface 101 is able to produce a sound similar to a tom drum as you move away from the area where the snare wire interfaces with surface 101. A handle 107 is attached to rear plate 105 for carrying the drum 100 during transportation.

The base plate 118 is supported by three legs 110. The legs are attached to the base plate 118 through leg mounts 144, which allow the legs to be completed disengaged from the base plate 118, or the leg mounts 144 allow the legs 110 to be rotated about a point and fold up and lock in place. The leg mounts 144 may have internal springs to assist in the opening of the legs 110. The length of the legs 110 is dependent on if the drum 100 is meant to be used sitting or standing, so the length of the legs 110 is based on the intended use and are removeable to adjust the height of the drum 100.

In some embodiments, the legs have rubber feet 154. Additionally in some embodiments, where the legs 110 are secured about a pivot point and engage with a bracket to secure the legs 110 when in the “open” position.

In some embodiments, the base plate 118 has an aperture 119. Aperture 119 is sized to receive a bass drum head 116, which is secured to the base plate 118 via fasteners or locking mechanisms 148. In the depicted embodiment, a pop off djembe style drumhead is used and mounting brackets with rubber pads are used to secure the drum head in place. In the depicted embodiment, the bass drum head 116 has a contact pad 146 attached to the bottom approximately where the beater 112 hits the bass drum head 116, to reduce resonances and lower wear produced by the beater contact. This contact pad is made from a felt-like material. The top surface has pad 126 is affixed to the bass drum head 116 which also dampens undesirable resonances and lowers the overall frequency produced by the drum head. The contact pad 146 and top surface pad 126 is, in one embodiment, a laminate of felt and low durometer rubber. In additional embodiments, the contact pad 146 and the top surface pad 126 may be made from a variety of materials.

A bass drum assembly is integrated into the drum 100. Foot pedal assembly 111 comprises a foot pedal, a foot plate, and a spring which attach to a cable 141. The cable interfaces with the rocker assembly 117. The rocker assembly 117 comprises a cable lock connected to the rocker 156 that is attached to the beater holder 158. The beater holder has the beater 112 installed that interacts with the bass drum head 116. A beater return spring 160 has an adjustable rotating guide so that both the spring force and angle increase as the beater 112 approaches the bass drum surface 116. This helps shorten the drum surface contact time and makes possible a crisper strike. The knob 162 at the rear provides overall spring tension adjustment and makes changing the spring 160 easy. The foot pedal cable shield is attached to leg 110 and folds closed with the leg 110. The rocker assembly 117 is attached to the base plate 118 and through the cable 141, the pedal 111 is able to be placed where necessary by the drummer. There are various adjustments integrated into the bass drum to allow for customization of the feel and response of the base drum. The foot pedal assembly 111, with a cable 141 of a predetermined length. By detaching the cable 141, the foot pedal assembly 111 can be stored within a padded bag which fits inside the drum 100 for transport.

The length of the legs 110 affects the length of the cable 141 for the base drum pedal assembly. The rear leg 110, in a seated configuration, is adjustable for the height desired by the user.

In the depicted embodiment, mounts 121 are secured to surface 118 of the frame to allow for various sound adjustment plates 131 to be inserted into the drum 100 to effect the sound of the drum(s). These sound adjustment plates 131 may be made from various materials to allow the drummer to produce different sounds or tones from one or more of the drums. In the depicted embodiment, the sound adjustment plates 131 is a bass wave guide plate added above the bass drum head which runs from near the front to near the back of the drum 100. This lengthens the bass note path and helps affect the bass note(s), frequency, tone, and duration. It also helps isolate the bass drumhead and top plate, preventing resonances caused by each other. This may be made from, but not limited to plastic such as polyethylene, ABS, polycarbonate or thin bending plywood. The sound adjustment plates 131 is installed above the bass drum heads 116 to deflect the sound of the bass drum when used. The sound adjustment plates 131 is secured within guide rails 121. In the depicted embodiment, the guide rails 121 have a slot that sound adjustment plates 131 fits into. In other embodiments, the sound adjustment plates 131 may be secured to the guide rails 121 through fasteners or adhesives.

In some embodiments, drum stick holders 150 are attached to the drum 100 to allow for the drummer to also store their drum sticks on the drum 100 during transportation, or to keep an extra pair of drum sticks available while playing. The position of the drum stick holders does not interfere with the other features of the drum 100.

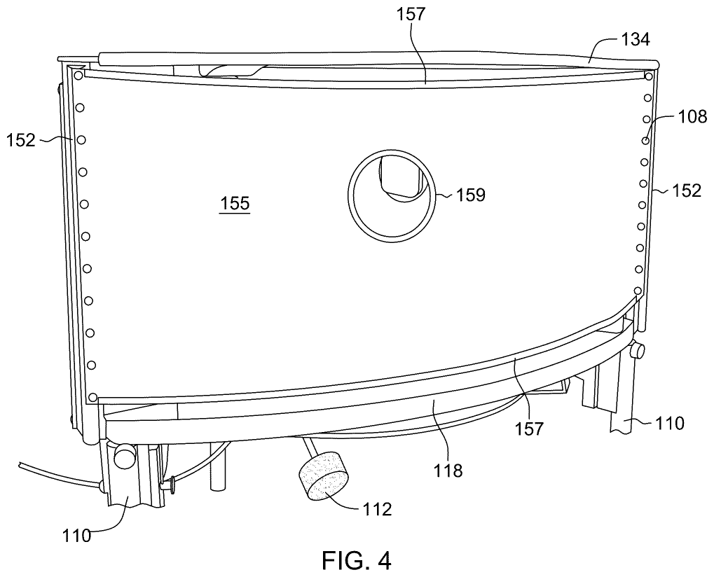

As shown in FIG. 4, a front plate 155 is secured to the frame to enclose the internal components of the drum 100. The front plate 155 has a predetermined convex shape and is made from a predetermined material to assist with the sounds, notes, and tones, created by the surfaces 101, 102, and 103 and the bass drum. The convex shape of the front plate 155 is based on the shape of the frame 104. The front plate 155 is secured to the front supports 152 via fasteners 108. The top edge of the front plate 155 is curved so that the surface 101 when struck does not come in contact with the front plate 155. The curvature of the top edge is shown in one embodiment but may have varying curvatures based on the intended sounds and notes to be produced. The bottom edge of the front plate 155 is substantially flat so that the front plate will not contact the bottom plate 118 when the base drum is played, but to create a gap between the front plate 155 and the base plate 118 to improve the sound, note, and tone of the base drum. The curvature of the bottom edge is shown in one embodiment but may have varying curvatures based on the intended sounds and notes to be produced. In some embodiments, the front plate 155, has a coating or edge cover 157 to further enhance the sound produced by the drum 100. Opening 159 is present in the front plate 155 to assist with the sounds, notes, and tones of the base drum. The location and size of opening 159 is shown in one embodiment but may be repositioned on front plate 155 and may be various sizes or shapes. The front plate 155 is curved in one plane to add tension to create both a speaker surface and ports. The front plate 155 can be made from, but not limited to clear polycarbonate, ABS plastic, or thin birch plywood.

The upper port tunes the mid to lower tones towards the middle and the high tones near the sides. An optional circular port lower on the face enhances the bass tones. Rounded trim strips along the port edges reduce tonal distortion.

The aperture 123 provides a more balanced bass sound for the drummer's position. In the depicted embodiment, a rear corner reflector plate 130 is secured to the rear plate 105 and base plate 118 via fasteners 142. In one embodiment the rear corner reflector plate 130 is secured to the mounting bracket 132. This rear corner reflector plate 130 creates a second path for the bass drum and provides the advantage of creating a sound that mimics that of a larger space. By creating the two paths for the bass drum sound, the sound is amplified. The rear corner reflector plate 130 directs the sound off the rear corner reflector plate 130 upwards, as well as backwards. Additionally, based on the aperture 123 in the rear plate 105, the sound is also directed towards the player.

Secured to frame base plate 118 is cymbal mount 125. The cymbal mount 125 provides an attachment point for cymbal arm 114. In the depicted embodiment, there is one cymbal mount 125 positioned substantially in the center of the drum. In additional embodiments, there may be more than one cymbal mount 125 positioned at various places along the edge of the base plate 118 to keep the drum stable and evenly distribute the weight of the cymbals. For an example if two cymbals are used, the cymbal mounts 125 would be at opposite ends of the base plate 118. The cymbal mount 125 is secured in place via openings 136 through the base plate 118. As shown in the present embodiment there are three sets of openings 136. In additional embodiments, the openings 136 may be in different locations or quantities based on the cymbal mount 125. Cymbal arms 114 are well known in the art and the present invention allows for a variety of cymbal arms to be attached to the drum 100. In the depicted embodiment, a double pivot arm is shown. Attached to cymbal arm 114 is cymbal 115. A variety of cymbals may be attached to cymbal arm 114 based on the drummer's preference. In the depicted embodiment, the base plate 118 has a plurality of openings 136 which allow for various mounting points for the cymbal mount 125 to be secured to. The cymbal mount 125 is secured to the base plate 118 via fasteners or various locking mechanisms.

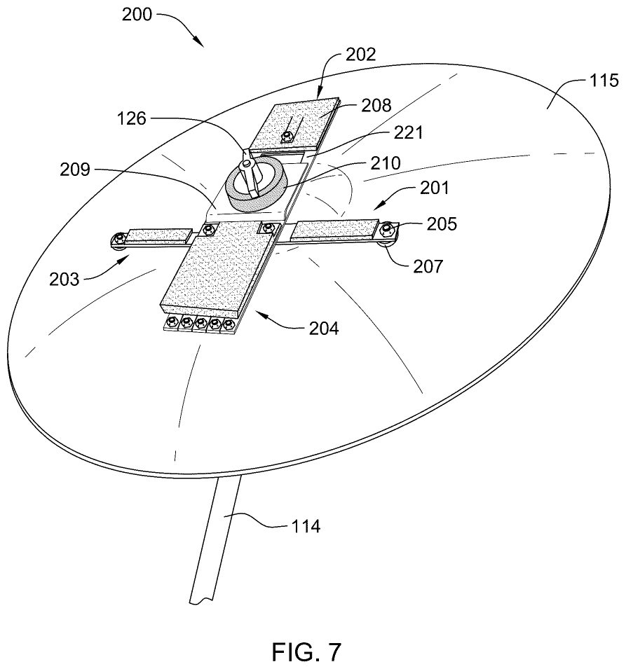

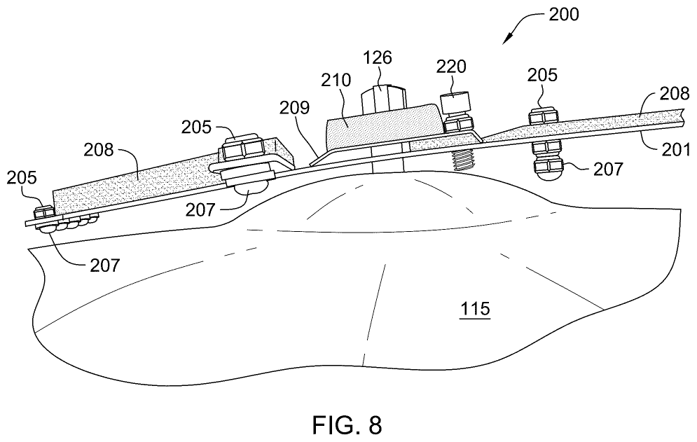

As shown in FIGS. 7-8 a cymbal taps assembly 200 is shown attached to the cymbal 115, in accordance with one embodiment of the present invention.

The cymbal taps assembly 200 has at least one pad positioned between the cymbal taps assembly 200 and the cymbal 115. The felt pad is adjustable so that positioning of the cymbal taps assembly 200 relative to the cymbal 115 can be set to the user's preferred distance. This adjustment affects the gap between the cymbal 115 to the multiple arms. Secured between the cymbal 115 and the locking nut 126 (and felt pad 210), the cymbal taps assembly 200 allows for a variety of sounds to be produced by a single cymbal. In a typical drum set there are a variety of cymbals which can be used; crash, china, ride, splash, stack, hi-hat, and each of these have may different types as well based on size, material, and the like. The cymbal taps assembly 200 provides a single component that when attached to the cymbal 115 allows the player to hit the cymbal taps assembly 200 to produce sounds that replicate the various cymbal types. In the depicted embodiment, the cymbal taps assembly 200 is comprised of a base 209, and a main body 221 with arms 201, 202, 203, and 204 which each arm a different sound. The base 209 is mounted on top of the main body 221 and both have central openings which align and are secured about the bolt which holds the cymbal 115. The base 209 has an adjustment screw 220 which is used to adjust the angling of the cymbal taps assembly 200. Each arm is comprised of a structural frame member which extends from the main body 221. Each of the structural frame members are of a predetermined size based on desired sound to be created. Each arm has a felt cover 208 which extends over a large portion of the arm. Each arm has at least one aperture (based on the arm size and the desired sound), and a contact pad 207 is secured through the open(s) with a fastener 205. The contact pad 207 is made from various materials based on the intended sound to be created. Fasteners 205 alone may also make direct contact with cymbal 115 if a bright sound is desirable.

In additional embodiments, the drum 100 is sized to fit the cymbal 115 within the internal compartment of the drum 100. In some embodiments, a bag is used that fits the cymbal 115 inside, so that the cymbal 115 when placed within the drum 100 does not damage any of the internal components. Additionally, microphones or pick-ups can be attached to the drum 100 or inserted inside the drum 100 to allow for amplification of the various sounds produced by the drum when connected to speaker(s). In some embodiments, microphone mounts may be attached to the drum 100 at various locations to allow for the microphones to be used.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

It will be further understood that various changes in the details, materials, and arrangements of the parts which have been described and illustrated in order to explain the nature of this invention may be made by those skilled in the art without departing from the scope of the invention as expressed in the following claims.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A drum comprising:
a frame;
a base plate having an aperture attached to the frame;
a top surface secured to the frame;
a first side surface secured to the frame; and
a second side surface secured to the frame.

2. The drum of claim 1, further comprising, a set of legs attached to the base plate of the frame.

3. The drum of claim 1, further comprising, a snare wire assembly, wherein the snare wire assembly interfaces with the top surface.

4. The drum of claim 1, further comprising, a cymbal mount, wherein the cymbal mount is secured to the base plate of the frame assembly.

5. The drum of claim 4, further comprising, a cymbal assembly attached to the cymbal mount.

6. The drum of claim 1, further comprising, a bass drum head secured to the base plate, wherein the bass drum head covers the aperture.

7. The drum of claim 6, further comprising, a bass drum beater assembly that is secured to an exterior surface of the base plate, wherein a bass drum beater is positioned to interface with the bass drum head.

8. The drum of claim 7, further comprising, a bass drum pedal assembly mechanically connected to the bass drum beater assembly.

9. The drum of claim 1, further comprising, a front plate, wherein the front plate is secured to the frame.

10. The drum of claim 1, further comprising, a set of drum stick holders secured to the exterior surface of the base plate.

11. The drum of claim 1, further comprising, a set of rails attached to the base plate and positioned relative to the aperture.

12. The drum of claim 11, further comprising, a flexible plate secured to the set of rails.

13. The drum of claim 1, further comprising, a reflector plate secured to the frame and the base plate.

14. A drum comprising:
a frame, wherein the frame has a base plate and wherein the base plate has an aperture;
a top surface secured to the frame;
a first side surface secured to the frame;
a second side surface secured to the frame;
a front plate secured to the frame;
a snare assembly integrated into the frame and interfacing with the top surface; and
a bass drum beater assembly secured to the frame.

15. The drum of claim 14, wherein the base plate as an aperture.

16. The drum of claim 14, further comprising, a cymbal mount secured in at least one of the set of apertures of the base plate.

17. The drum of claim 14, further comprising a set of legs, wherein the legs are secured to the base plate.

18. The drum of claim 17, wherein the legs are rotatably engaged with the base plate.

19. A drum comprising:
a frame, wherein the frame comprises:
a base plate,
at set of vertical members, wherein the vertical members interface with the base plate at predetermined positions, and
a top plate secured to the set of vertical members;
a top surface secured to the frame;
a first side surface secured to the frame;
a second side surface secured to the frame;
a snare assembly integrated into the frame and interfacing with the top surface;
a bass drum beater assembly secured to the frame; and
a cymbal mount assembly attached to the base plate.

20. The drum of claim 19, further comprising, a cymbal tap assembly attached to a cymbal, which is mounted to the cymbal mount assembly.
